(19) United States
(12) Patent Application Publication
(10) Pub. No.: US 2019/0272764 A1
(43) Pub. Date: Sep. 5, 2019

(54) MULTIDIMENSIONAL ASSESSMENT SCORING USING MACHINE LEARNING

(71) Applicant: ACT, INC., Iowa City, IA (US)

(72) Inventors: JAY THOMAS, Iowa City, IA (US); BRADLEY BOLENDER, Iowa City, IA (US); RICHARD D. MEISNER, Iowa City, IA (US); JAMES GAMBRELL, Iowa City, IA (US)

(21) Appl. No.: 15/911,098

(22) Filed: Mar. 3, 2018

(51) Int. Cl. G09B 7/02; G06N 99/00; G09B 7/077

(52) U.S. Cl. CPC G09B 7/02; G09B 19/00; G09B 7/077; G06N 99/005

(57) ABSTRACT

Systems and methods for enhanced monitoring of learning progressions include obtaining a first set of examinations and a first set of responses corresponding to the first set of examinations, a first set of examination assessments, training a machine-learning multidimensional scoring model based on the first set of examinations, the first set of responses, and the first set of examination assessments, generating a confusion matrix based on the first set of examination assessments, determining a performance assessment value from the confusion matrix, and determining that the multidimensional scoring model has been sufficiently trained if the performance assessment value meets or exceeds a selected threshold value.

### STATEMENT REGARDING FEDERAL RIGHTS

The technology disclosed herein was developed with government support under Contract No. NSF 14-522 awarded by the U.S. National Science Foundation The government has certain rights in the invention.

### TECHNICAL FIELD

The disclosed technology relates generally to learning assessments, and more particularly various embodiments relate to systems and methods for multidimensional composite assessment scoring using machine learning.

### BACKGROUND

Assessment examinations have been used to monitor and affect learning progressions in students. Techniques for gathering sufficient data from enough students to validate the learning progression has posed challenges. For example, it is costly and time consuming to score responses that include written explanations that address key practices like arguing from evidence and cross-cutting concepts in patterns. In the context of science assessments, it is difficult to reliably monitor the existence of relationships in conceptual learning progression, such as the learning of cause and effect, matter cycles, and energy fluxes. Additionally, the Next Generation Science Standards (NGSS) call for integrating multiple dimensions of learning: science and engineering practices, cross cutting concepts in science, and disciplinary core ideas.

Moreover, the use of composite items that include both forced choice and extended response portions are becoming more widely used to provide additional diagnostic information about the test taker. Traditional scoring approaches evaluate forced choice and constructed responses separately. Thus, while the use of composite, or combined forced choice and constructed response type questions, can provide additional insight into a learning progression, there are no methods available to efficiently score the composite examinations in a reliable and consistent manner that enables a holistic analysis between the different response types.

### BRIEF SUMMARY OF EMBODIMENTS

Systems and methods for enhanced monitoring of learning progression are provided. An example method of enhanced monitoring of learning progression may include generating a written exemplar worksheet (WEW), a rubric used to train human coders, for the human-scored composite examinations based on examination features associated with each question, using the WEW to code enough responses to create a training set, and training a scoring model using a machine learning algorithm with the training set data, and validating the reliability of the scoring model by using confusion matrices. A machine learning model may be applied to evaluate composite items with forced choice and constructed responses as a whole to accurately score the student response and provide a sub-score indicator which could be used as a formative assessment feedback to guide future instruction. The features, parameters, and inputs to the machine learning scoring model may be modified until the model meets a reliability parameter (e.g., a learning performance parameters generated from analysis of the confusion matrices exceeds a threshold value).

Some embodiments of the present disclosure provide a computer implemented method for enhancing monitoring of learning progression. In some examples, the method includes obtaining a first set of examination and first set of responses corresponding to examinations. For example, the first set of examinations may be learning assessments comprising questions eliciting forced choice responses, constructed responses, and/or mixed responses. The method may include generating a first set of examination assessments by critiquing each of the first set of responses, and compiling the critique responses in a relational database. In some examples, critiquing the first set of responses may be performed using a graphical user interface (e.g., using a human grader).

In some embodiments, the method includes training a multidimensional scoring model based on the first set of examinations, the first set of responses, and the first set of examination assessments. For example, the multidimensional scoring model may be a machine learning model. The method may include generating a confusion matrix based on the first set of examination assessments. For example, the confusion matrix may be a table that used to describe the performance of a classification model on a set of data for which the true values are known. Some examples of the method includes determining a performance assessment value from the confusion matrix. For example, the performance assessment value may be a Kappa, a quadratic weighted Kappa, a F score, a Matthews correlation coefficient, informedness, a ROC curve, a null error rate, a positive predictive value, a prevalence, a precision, a specificity, a sensitivity, a true positive rate, a misclassification rate, a false omission rate, a false discovery rate, a fall-out, a miss rate, a negative predictive value, an accuracy, or other performance assessment values calculated from confusion matrices as known in the art.

In some embodiments, the method includes determining that the multidimensional scoring model has been sufficiently trained if the performance assessment value exceeds the selected threshold value. For example, in the case of a performance assessment value being a quadratic weighted Kappa, the selected threshold value may be 0.6 in some examples. In some examples, the selected threshold value for a quadratic weighted Kappa may be 0.7. In some embodiments, the selected threshold value for the performance assessment value may be entered using the graphical user interface, selected randomly, were pre-coded into the machine learning model.

In some embodiments, the method may include obtaining a second set of examinations and a second set of responses corresponding to the second set of examinations. The method may include applying the trained multidimensional scoring model to each of the second set of responses and second set of examinations to determine a learning progression level associated with each response of the second set of responses. For example, the learning progression level may be associated with an individual learner (e.g., a student). The learning progression level may be used to indicate the learner's competence with respect to one or more subjects, and provide recommendations to the learner to improve. In some embodiments, the learning progression level may be a grade or examination score. Some example methods also include displaying the learning progression level on the graphical user interface. The method may also include applying the trained multidimensional scoring model to each of the second set of responses and second set of examinations to determine a learner progression sub level representing a learner error type.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates an example system for multidimensional composite assessment scoring using machine learning, consistent with embodiments disclosed herein.

FIGS. 2A and 2B are flowcharts illustrating an example method for multidimensional composite assessment scoring using machine learning, consistent with embodiments disclosed herein.

FIGS. 3A-3C illustrate example composite assessment questions used to assess learning performance, consistent with embodiments disclosed herein.

FIG. 3D illustrates an example multidimensional machine learning scoring model for composite scoring using a decision tree, consistent with embodiments disclosed herein.

FIG. 4 is a flowchart illustrating an example method for multidimensional composite assessment scoring using machine learning, consistent with embodiments disclosed herein.

FIG. 5 illustrates an example computing system that may be used in implementing various features of embodiments of the disclosed technology.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

Embodiments of the technology disclosed herein are directed toward systems and methods for multidimensional composite assessment scoring using machine learning. Disclosed embodiments provide scalable systems and methods for electronically scoring composite examinations that include questions eliciting both forced choice and constructed responses to holistically assess, track, and enhance learning progression of individual learners. The multiple dimensions of the multidimensional composite assessment scoring systems and methods may include, for example, science and engineering practices, cross cutting concepts in science, and disciplinary core content. Each of these dimensions may be tested individually using various question formats, e.g., questions that elicit forced choice, constructed response, and/or mixed response formats.

A multidimensional scoring model may be applied to assess performance across multiple dimensions by designing assessments with composite question formats using mixed question format types in testing for more than one dimension at the same time. The scoring of these composite examinations may be enhanced using machine learning algorithm to correlate responses in progress from each learner across the multiple dimensions because those multiple dimensions are integrated in related-fashion within individual questions

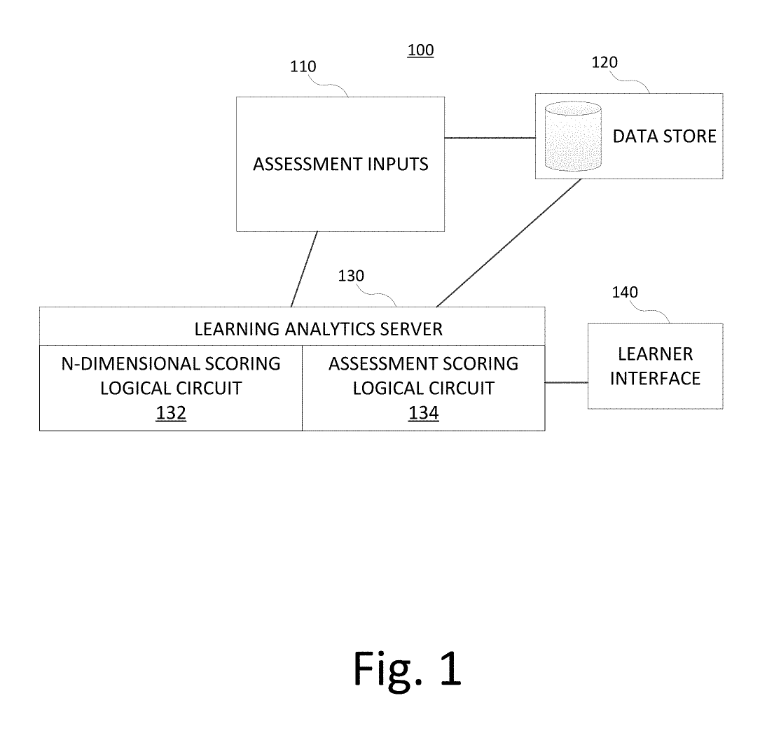

FIG. 1 illustrates an example system for multidimensional composite assessment scoring 100 using machine learning. Referring to FIG. 1, system 100 may include a learning analytics server 130. Learning analytics server 130 may include one or more logical circuits configured to perform one or more operations of the methods disclosed herein. Logical circuits may include one or more processors and one or more non-transitory memories with computer executable instructions embedded thereon, the computer executable instructions configured to cause the processor to perform one or more operations of the methods disclosed herein. In some embodiments, learning analytics server 130 may include an N-dimensional learning logical circuit 132 and/or assessment scoring logical circuit 134. N-dimensional learning logical circuit 132 may obtain assessment inputs 110 and an N-dimensional scoring model (i.e., a multidimensional scoring model) from data store 120. For example, the N-dimensional learning model may be a machine learning model which may be trained using the assessment inputs 110. For example assessment inputs 110 may include sets of examinations and corresponding responses to questions and those examinations. The examination responses may be real examinations administered to learners or synthetic examinations and predicted responses thereto.

The examinations may include multiple question formats. For example, some questions may elicit forced choice responses. Some questions may elicit constructed responses. Some questions may elicit a mixed format response, such as a constructed or freeform response to one part of the question, and a forced choice response to another part of the question related to the constructed response. Assessment inputs 110 may also include examination assessments obtained from learner interface 140 and/or data store 120. For example, examination assessments may include critiqued responses to the examinations, wherein the critiquing is performed by a human grader to provide a scoring rubric for each examination and response thereto. N-dimensional learning logical circuit 132 may then analyze answers to the examinations together with examination assessments to learn how a particular examination and response should be scored. N-dimensional learning logical circuit 132 may apply machine learning models such as the convolutional neural network, the decision tree, logistic regression, Bayes network or other machine learning algorithms as known in the art. The trained version of the N-dimensional learning model may be stored in data store 120.

In some embodiments, learning analytics server 130 includes assessment scoring logical circuit 134. Assessment scoring logical circuit 134 may obtain underscored composite examinations and responses thereto from data store 120 and/or learner interface 140. Assessment scoring logical circuit 134 may apply the trained N-dimensional scoring model to the unscored examinations and responses to determine learner progression for individual learners.

In some examples, learner interface 140 may be a graphical user interface. Learner interface 140 may be integrated on learning analytics server 130, or may be a remote workstation, computer, laptop, tablet, mobile device, scanner, fax machine, or other input device as known in the art. Data store 120 may be a local data storage device, a network data storage device, a cloud-based data storage device, or other storage device as known in the art. Learning analytics server 130 may communicate with learner interface 140, data store 120, and/or assessment inputs 110, over a direct connection, local area network, wide area network, wireless network, or other network communication system as known in the art. In some examples, learning analytics server 130 is operated from the cloud.

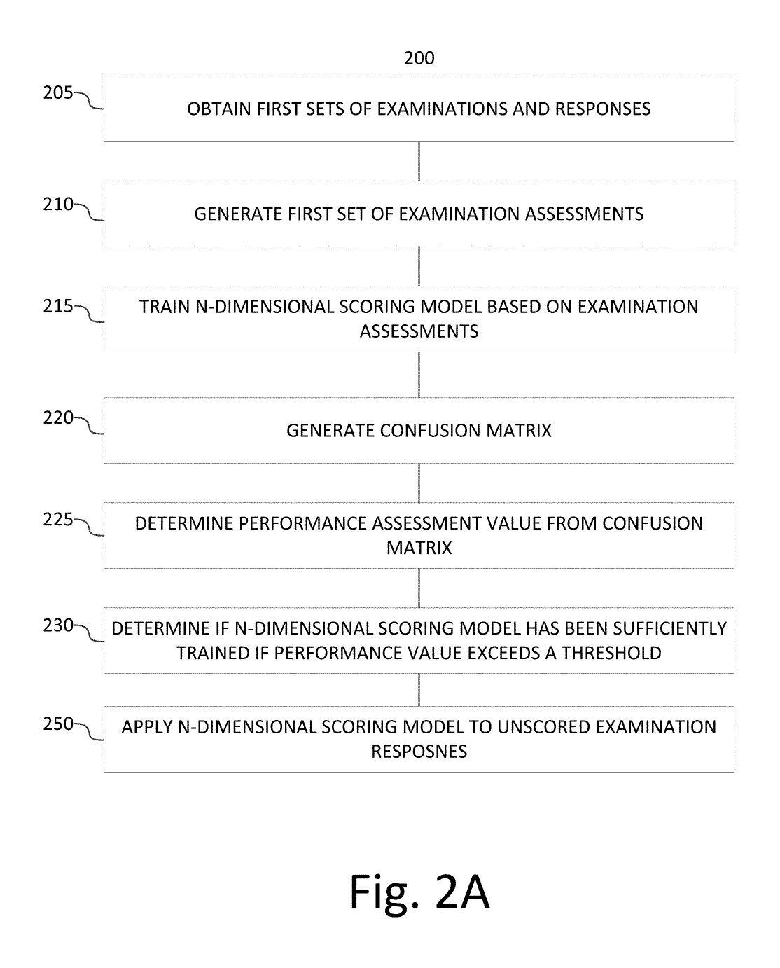

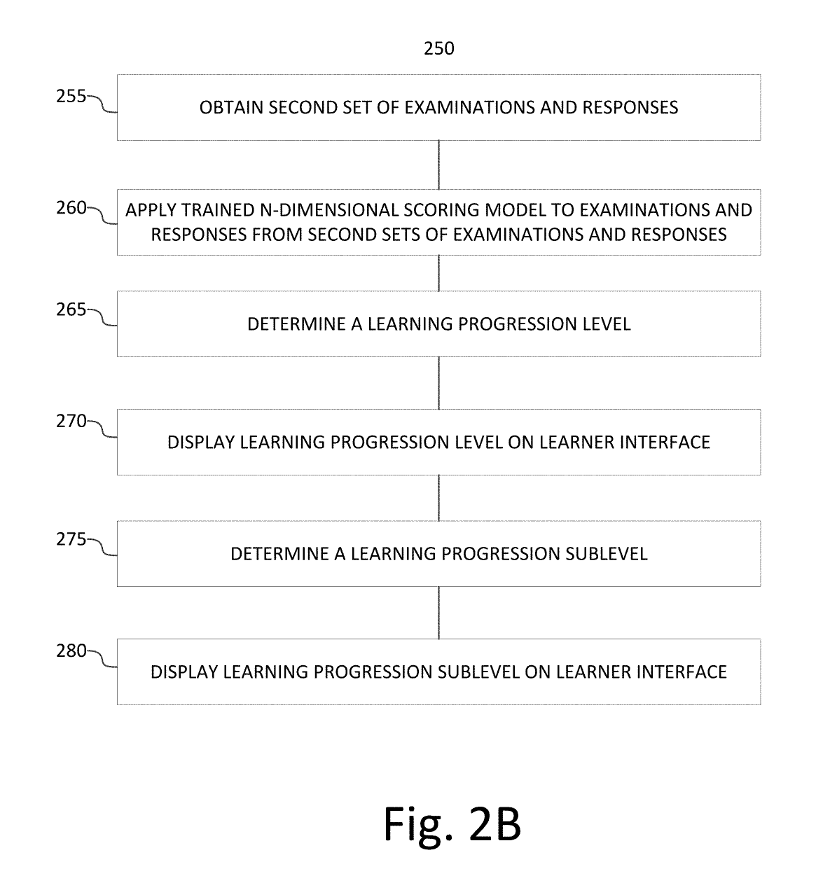

FIGS. 2A and 2B are flowcharts illustrating an example method for multidimensional composite assessment scoring using machine learning. Referring to FIG. 2A, a method for training multidimensional scoring model 200 may include obtaining first sets of examinations and responses at step 205. For example obtaining the first sets of examination responses may include receiving one or more examinations in one or more sets of corresponding responses for me user interface and/or data store. The examinations may be composite examinations as discussed herein. Some examples, historic sets of already administered examinations may be used.

Method 200 may also include generating first sets of examination assessments at step 210. For example, generating examination assessments may be performed by one or more human graders through user interface. As such, the human graders may critique each set of responses for each examination and provide examination assessments for each examination. The examination assessments may be compiled into a scoring rubric. For example, multiple response sets for the same examination administered of different learners may be compiled to provide example examination and response pairs for each level of critique. The human-graded critiques may be scored based on written exemplar worksheets (WEW). WEW's may be created for particular examination and response sets by a master grader(s). WEW are rubrics based on multidimensional learning. WEW's may be used to train human graders to create the training set.

In some examples, human graders may score student responses by assigning a learning progression level and sublevel to each response. The sublevel may be tied to a specific student error, misconception, or omission. Once a set that contains a statistically significant data set for each sub-level is created, the training set may be considered complete. In some examples, the statistically significant number of responses to be scored for each sublevel may be 25 or more. In some examples, the statistically significant number of responses to be scored for each sublevel may be about 70. Varying numbers of responses per sublevel may be scored depending on a desired level of statistical confidence in the results.

In some embodiments, method 200 includes training a multidimensional scoring model based on the examination assessments at step 215. Training the multidimensional scoring model may employ machine learning techniques such as a convolutional neural network, a decision tree, a logistic regression, Bayes network, or other machine learning techniques as known in the art. The training set may be converted to a standardized format (e.g., a standard document or database type, with standardized character types, language, etc.). Features from the responses may then be extracted. In some examples, the sublevel code may be selected as a nominal category rather than a numerical category. The method may include extracting forced choice responses as an additional feature to be evaluated by the scoring logical circuit (e.g., N-dimensional scoring logical circuit 132), and the value of the extracted forced choice response may be holistically evaluated with the scores of constructed choice responses. As such, the forced choice responses may not be scored as dichotomous or polytomous data and summed. Features of interest may be selected and/or identified and extracted.

Some embodiments, may include performing a regression of the machine-predicted evaluation assessment data and corresponding human-graded evaluation assessment data with N-dimensional scoring logical circuit 132. In some examples, a subsequent training pass may be performed on a smaller subset of features.

Method 200 may include generating a confusion matrix to the examination assessments. The confusion matrix may be a table that is used to describe the performance of a classification model on a set of test data for which true values are known. In this case, the true values for the examinations and responses may be the scoring rubric of compiled human-graded examination assessments. The classification model may be the multidimensional scoring model In some examples, the multidimensional scoring model may be applied to examinations and responses to predictively critique those responses, and the machine-graded results may then be compiled in the confusion matrix as compared with the human-graded results as described herein.

Method 200 may include determining a performance assessment value from the confusion matrix at step 225. For example, the performance assessment value may be a Kappa, a quadratic weighted Kappa, a F score, a Matthews correlation coefficient, informedness, a ROC curve, a null error rate, a positive predictive value, a prevalence, a precision, a specificity, a sensitivity, a true positive rate, a misclassification rate, a false omission rate, a false discovery rate, a fall-out, a miss rate, a negative predictive value, an accuracy, or other performance assessment values calculated from confusion matrices as known in the art. In some embodiments, the method may include calculating a sublevel accuracy, level accuracy, Kappa, and Quadratic Weighted Kappa (QWK). In some example, other combinations of performance assessment values may be calculated.

Embodiments of method 200 may include determining that the multidimensional scoring model has been sufficiently trained if the performance enhancement value exceeds a threshold level at step 230. The threshold level may be pre-determined (e.g., coded in the multidimensional scoring model), or may be obtained from a user (e.g., through a graphical user interface). In some examples, the performance assessment value includes a QWK. The multidimensional scoring model may be trained while varying the number of features used by the model to find a maximum QWK value. In some examples, the multidimensional scoring model may be considered sufficiently trained if QWK is greater than about 0.6. In some examples, the multidimensional scoring model may be considered sufficiently trained if QWK is greater than about 0.7. If the threshold value is not reached, a different machine learning model may be selected, e.g., a convolutional neural network, decision tree, logistic regression, Bayes network, or other machine learning model as known in the art.

In some embodiments, method 200 may include applying the multidimensional scoring model to unscored examination responses at step 250. For example unscored responses may be examinations taken by one or more learners which have not been human graded. For example, referring to FIG. 2B, a method for applying the multidimensional scoring model to unscored examination responses may include obtaining a second set of examinations and responses at step 255. The second set of examinations and responses may be obtained from data store 120 and/or learner interface 140. In some examples, learner interface 140 may include an electronic testing interface enabling learners to take examinations and submit responses to learning analytics server 130 for scoring by the multidimensional scoring model. In some examples, previously taken examinations and responses may be uploaded through learner interface 140 from electronic documents or scanned paper documents.

Method for applying the multidimensional scoring model to unscored examination responses 250 may include applying the trained multidimensional scoring model to examinations and responses from the second sets of examinations and responses at step 260. No human grading is necessary at this step. However, human grading may still be applied for quality assurance, to verify anomalous results, and/or to continue to train the multidimensional scoring model.

In some embodiments, method 250 includes determining a learning progression level at step 265. The learning progression level may be a score or grade generated by the multidimensional scoring model for one or more scored responses. In some examples, a learning progression level may be generated for multiple dimensions of learning, e.g., science and engineering practices, cross cutting concepts in science, and/or disciplinary core ideas. The learning progression level(s) may be displayed on learner interface 140 at step 270. For example, learner interface 140 may include a graphical user interface configured to display individualized scoring results. In some examples, learner interface 140 may provide a learner with recommendations for studying, test preparation, and/or test taking based on the learning progression level(s).

Some examples of method 250 include determining a learning progression sublevel at step 275. For example, the sublevel may be tied to specific student errors, misconceptions, or omissions. Method 250 may also include displaying the learning progression sublevel(s) on learner interface 140.

### Example 1

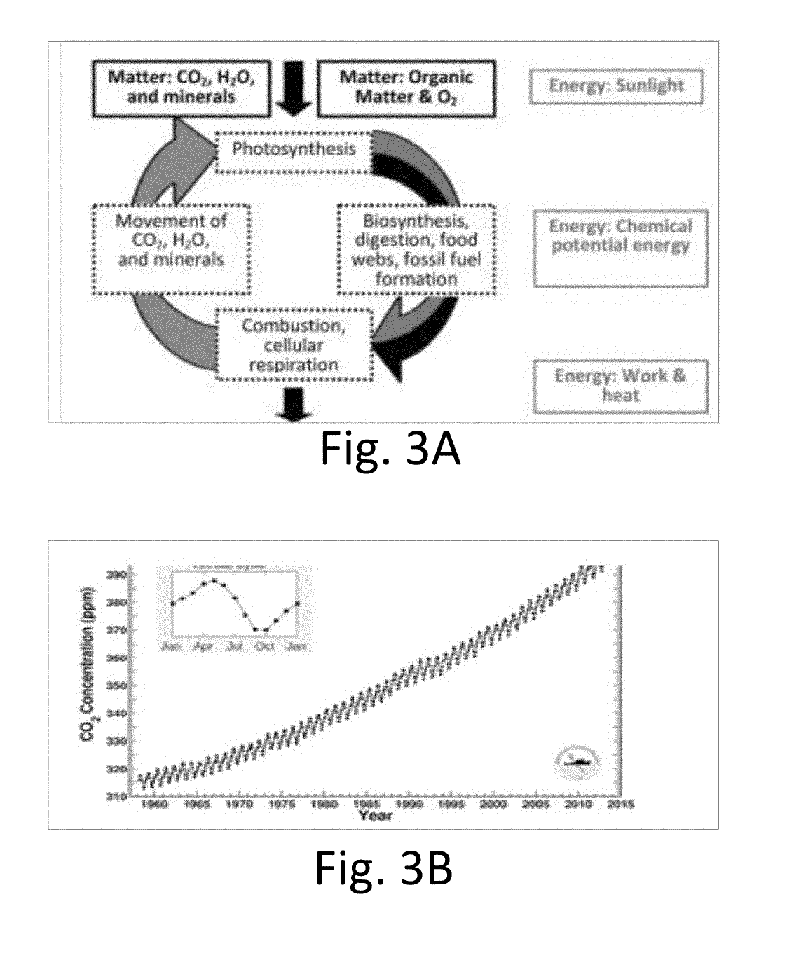

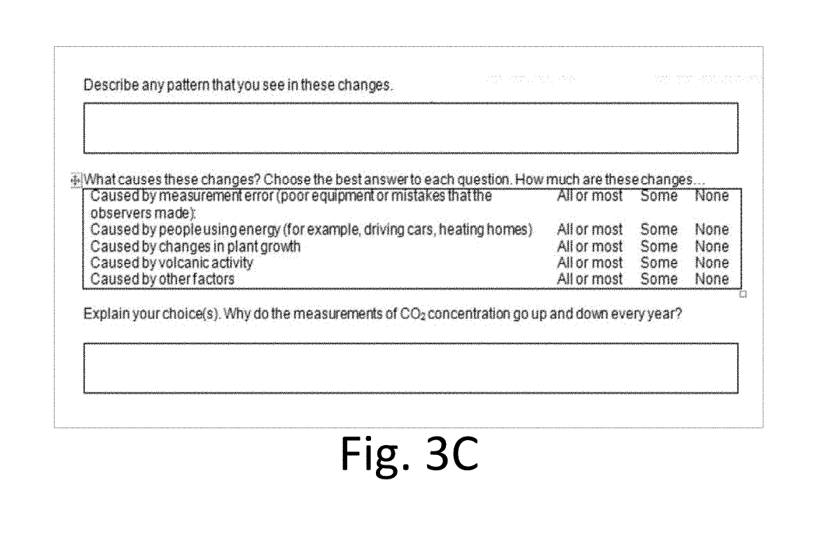

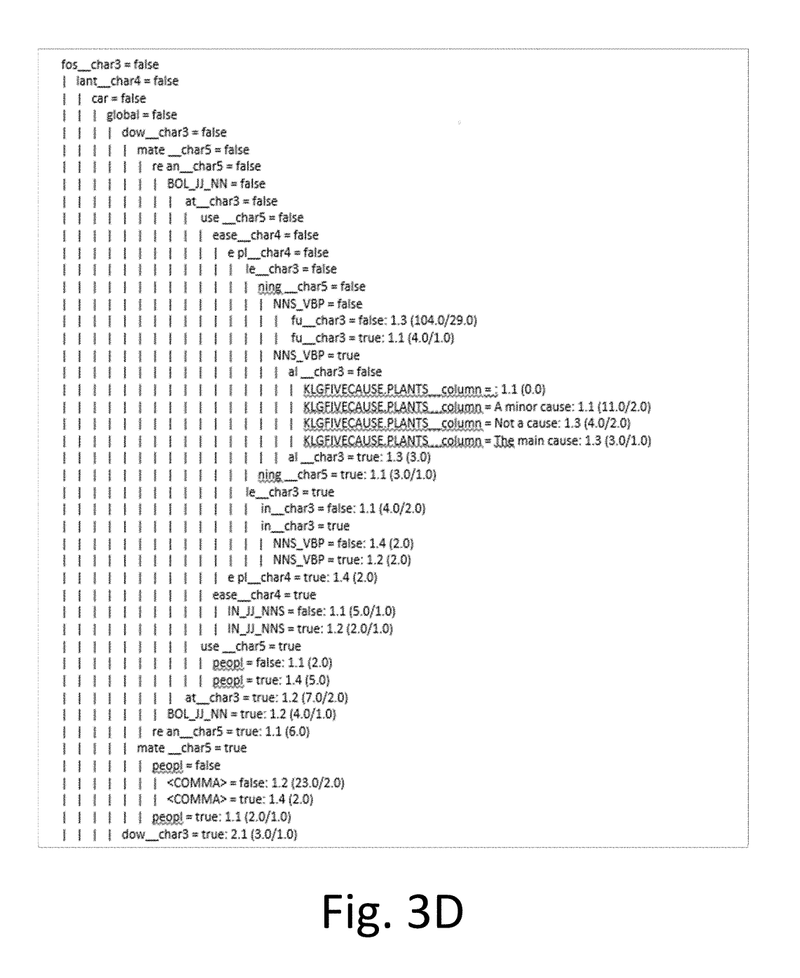

FIGS. 3A-3C illustrate example composite assessment questions used to assess learning performance. By way of non-limiting example, FIG. 3A illustrates one of many possible example mixed format questions used by a multidimensional learning model to gauge learner progression. In the example illustrated in FIG. 3A, a learner may be presented with information helpful to deducing conclusions about a scientific process. In the example illustrated, a photosynthesis process is depicted in which energy, in the form of sunlight, chemical potential energy, and work and heat, may be used by plant cells to act on H₂O and CO₂ to produce sugars and O₂. The chart illustrated in FIG. 3B may also be presented to the learner demonstrating an increasing overall CO₂ rate over many years, but cyclical CO₂ fluctuation within the overall increasing trend. FIG. 3C illustrates example questions in view of the information provided in FIGS. 3A and 3B. As illustrated, the example question includes a constructed response section asking the learner to describe any pattern that the learner observes in the provided information. A full response would include both increasing trend and cyclical fluctuations. The question also includes a forced choice response asking the learner to identify what is causing changes. The question also provides a follow-up constructed response section asking the learner to explain his or her choices. Each question is designed to assess one or more learning dimensions. The responses are assessed holistically by the multidimensional scoring model.

FIG. 3D illustrates an example multidimensional machine learning model for composite scoring using a decision tree. The decision tree may be pre-configured in accordance with possible response choices to each question. The example illustrated in FIG. 3D is configured based on the example question illustrated in FIGS. 3A-3C. The decision tree may be pre-configured with initial scoring parameters based on the decision path. In some examples, the scoring parameters may be modified over time by N-dimensional scoring logical circuit 132 during training.

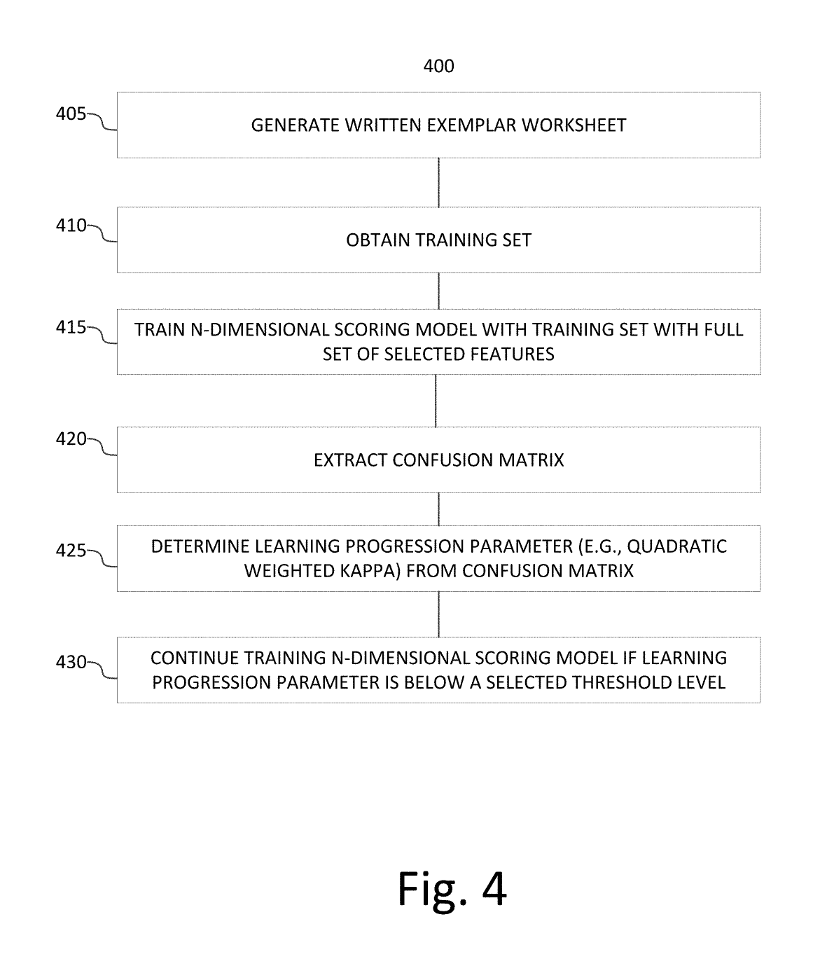

FIG. 4 is a flowchart illustrating an example method for multidimensional composite assessment scoring using machine learning. Referring to FIG. 4, an example method for multidimensional composite assessment scoring 400 may include generating a WEW at step 405 and obtaining a training set at step 410. The WEW may include a scoring rubric used by human graders to assess learning progression based on an examination designed to assess multidimensional learning progression, e.g., by eliciting constructed responses and, in some cases, forced choice responses from users.

Method 400 may include training a multidimensional scoring model with the training set using a full set of selected features at step 415 in a first training pass. In some examples, method 400 may also include applying a machine learning algorithm, e.g., a logistic regression to a smaller subset of features. Method 400 may also include extracting a confusion matrix at step 420 and determining a learning progression parameter (e.g., a QWK) from the confusion matrix at step 425. The multidimensional scoring model may be trained until the learning progression parameter exceeds a selected threshold (i.e., training continues if the learning progression parameter meets or exceeds the selected threshold) at step 430.

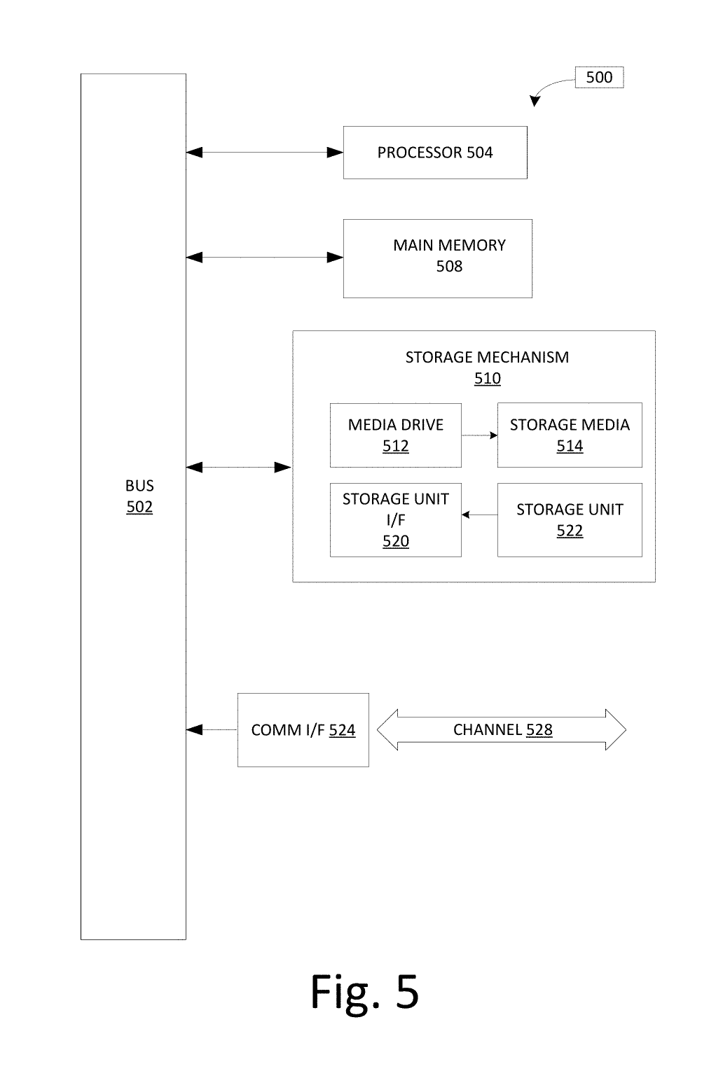

As used herein, the terms logical circuit and engine might describe a given unit of functionality that can be performed in accordance with one or more embodiments of the technology disclosed herein. As used herein, either a logical circuit or an engine might be implemented utilizing any form of hardware, software, or a combination thereof. For example, one or more processors, controllers, ASICs, PLAs, PALs, CPLDs, FPGAs, logical components, software routines or other mechanisms might be implemented to make up an engine. In implementation, the various engines described herein might be implemented as discrete engines or the functions and features described can be shared in part or in total among one or more engines. In other words, as would be apparent to one of ordinary skill in the art after reading this description, the various features and functionality described herein may be implemented in any given application and can be implemented in one or more separate or shared engines in various combinations and permutations. Even though various features or elements of functionality may be individually described or claimed as separate engines, one of ordinary skill in the art will understand that these features and functionality can be shared among one or more common software and hardware elements, and such description shall not require or imply that separate hardware or software components are used to implement such features or functionality.

Where components, logical circuits, or engines of the technology are implemented in whole or in part using software, in one embodiment, these software elements can be implemented to operate with a computing or logical circuit capable of carrying out the functionality described with respect thereto. One such example logical circuit is shown in FIG. 5. Various embodiments are described in terms of this example logical circuit 500. After reading this description, it will become apparent to a person skilled in the relevant art how to implement the technology using other logical circuits or architectures.

Referring now to FIG. 5, computing system 500 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Logical circuit 500 might also represent computing capabilities embedded within or otherwise available to a given device. For example, a logical circuit might be found in other electronic devices such as, for example, digital cameras, navigation systems, cellular telephones, portable computing devices, modems, routers, WAPs, terminals and other electronic devices that might include some form of processing capability.

Computing system 500 might include, for example, one or more processors, controllers, control engines, or other processing devices, such as a processor 504. Processor 504 might be implemented using a general-purpose or special-purpose processing engine such as, for example, a microprocessor, controller, or other control logic. In the illustrated example, processor 504 is connected to a bus 502, although any communication medium can be used to facilitate interaction with other components of logical circuit 500 or to communicate externally.

Computing system 500 might also include one or more memory engines, simply referred to herein as main memory 508. For example, preferably random access memory (RAM) or other dynamic memory, might be used for storing information and instructions to be executed by processor 504. Main memory 508 might also be used for storing temporary variables or other intermediate information during execution of instructions to be executed by processor 504. Logical circuit 500 might likewise include a read only memory (“ROM”) or other static storage device coupled to bus 502 for storing static information and instructions for processor 504.

The computing system 500 might also include one or more various forms of information storage mechanism 510, which might include, for example, a media drive 412 and a storage unit interface 520. The media drive 512 might include a drive or other mechanism to support fixed or removable storage media 514. For example, a hard disk drive, a floppy disk drive, a magnetic tape drive, an optical disk drive, a CD or DVD drive (R or RW), or other removable or fixed media drive might be provided. Accordingly, storage media 514 might include, for example, a hard disk, a floppy disk, magnetic tape, cartridge, optical disk, a CD or DVD, or other fixed or removable medium that is read by, written to or accessed by media drive 512. As these examples illustrate, the storage media 514 can include a computer usable storage medium having stored therein computer software or data.

In alternative embodiments, information storage mechanism 540 might include other similar instrumentalities for allowing computer programs or other instructions or data to be loaded into logical circuit 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory engine) and memory slot, a PCMCIA slot and card, and other fixed or removable storage units 522 and interfaces 520 that allow software and data to be transferred from the storage unit 522 to logical circuit 500.

Logical circuit 500 might also include a communications interface 524. Communications interface 524 might be used to allow software and data to be transferred between logical circuit 500 and external devices. Examples of communications interface 524 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 524 might typically be carried on signals, which can be electronic, electromagnetic (which includes optical) or other signals capable of being exchanged by a given communications interface 524. These signals might be provided to communications interface 524 via a channel 528. This channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the logical circuit 500 to perform features or functions of the disclosed technology as discussed herein.

Although FIG. 5 depicts a computer network, it is understood that the disclosure is not limited to operation with a computer network, but rather, the disclosure may be practiced in any suitable electronic device. Accordingly, the computer network depicted in FIG. 5 is for illustrative purposes only and thus is not meant to limit the disclosure in any respect.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent engine names other than those depicted herein can be applied to the various partitions.

Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “engine” does not imply that the components or functionality described or claimed as part of the engine are all configured in a common package. Indeed, any or all of the various components of an engine, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

I claim:

1. A computer implemented method for enhanced monitoring of learning progressions, the method comprising:
obtaining a first set of examinations and a first set of responses corresponding to the first set of examinations;
obtaining, from a graphical user interface, a first set of examination assessments;
training a multidimensional scoring model based on the first set of examinations, the first set of responses, and the first set of examination assessments;
generating a confusion matrix based on the first set of examination assessments;
determining a performance assessment value from the confusion matrix; and
determining that the multidimensional scoring model has been sufficiently trained if the performance assessment value exceeds a selected threshold value.

2. The method of claim 1, further comprising:
obtaining a second set of examinations and a second set of responses corresponding to the second set of examinations;
applying the trained multidimensional scoring model to each of the second set of responses and second set of examinations to determine a learning progression level associated with each response of the second set of responses; and
displaying the learning progression on the graphical user interface.

3. The method of claim 1, further comprising:
applying the trained multidimensional scoring model to each of the second set of responses and second set of examinations to determine a learner progression sublevel representing a learner error type; and
displaying the learner progression sublevel on the graphical user interface.

4. The method of claim 1, wherein the multidimensional scoring model comprises a machine learning process.

5. The method of claim 4, wherein the machine learning process comprises a convolutional neural network, a decision tree, Bayes networks, or a logistic regression.

6. The method of claim 1, wherein the first set of examinations comprise questions requiring constructed responses, forced choice responses, or mixed form responses.

7. The method of claim 1, wherein the first set of examinations comprise questions requiring constructed responses, forced choice responses, and mixed form responses.

8. The method of claim 7, wherein training the multidimensional scoring model further comprises determining a level of correlation between constructed responses and forced choice responses for related examination question features.

9. The method of claim 1, further comprising:
selecting a set of feature parameters from multiple examination questions of the first set of examinations; and
generating the first set of examination assessments by tokenizing each response into sub-responses according to the selected feature parameters and evaluating each sub-response.

10. The method of claim 9, further comprising adjusting a number of sub-features to increase the performance assessment value until the performance assessment value exceeds the selected threshold value.

11. The method of claim 1, wherein the performance assessment value comprises a Kappa value, a quadratic weighted Kappa value, an F score, a Matthews correlation coefficient, an informedness value, a null error rate, a positive predictive value, a negative predictive value, a prevalence value, a precision value, a specificity value, or a sensitivity value.

12. The method of claim 1, wherein the performance assessment value comprises a quadratic weighted Kappa value.

13. The method of claim 12, wherein the selected threshold value is more than about 0.6.

14. The method of claim 12, wherein the selected threshold value is more than about 0.7.

15. A system for enhanced monitoring of learning progressions, the system comprising:
a N-dimensional scoring logical circuit, a data store, and a graphical user interface, wherein the N-dimensional scoring logical circuit comprises a processor and a non-transitory medium with computer executable instructions embedded thereon, the computer executable instructions being configured to cause the processor to:
obtain, from the data store, a first set of examinations and a first set of responses corresponding to the first set of examinations;
obtain, from the graphical user interface, a first set of examination assessments;
train a multidimensional scoring model based on the first set of examinations, the first set of responses, and the first set of examination assessments;
generate a confusion matrix based on the first set of examination assessments;
determine a performance assessment value from the confusion matrix; and
determine that the multidimensional scoring model has been sufficiently trained if the performance assessment value exceeds a selected threshold value.

16. The system of claim 15, wherein the computer executable instructions are further configured to cause the processor to:
obtain a second set of examinations and a second set of responses corresponding to the second set of examinations;
apply the trained multidimensional scoring model to each of the second set of responses and second set of examinations to determine a learning progression level associated with each response of the second set of responses; and
display the learning progression on the graphical user interface.

17. The system of claim 15, wherein the computer executable instructions are further configured to cause the processor to:
apply the trained multidimensional scoring model to each of the second set of responses and second set of examinations to determine a learner progression sublevel representing a learner error type; and
display the learner progression sublevel on the graphical user interface.

18. The system of claim 15, wherein the multidimensional scoring model comprises a machine learning process.

19. The system of claim 15, wherein the machine learning process comprises a convolutional neural network, a decision tree, Bayes network, or a logistic regression.

20. A computer implemented method for enhanced monitoring of learning progressions, the method comprising:
obtaining a first set of examinations and a first set of responses corresponding to the first set of examinations;
obtaining, from a graphical user interface, a first set of examination assessments;
training a multidimensional scoring model based on the first set of examinations, the first set of responses, and the first set of examination assessments;
generating a confusion matrix based on the first set of examination assessments;
determining a Quadratic Weighted Kappa value from the confusion matrix; and
determining that the multidimensional scoring model has been sufficiently trained if the Quadratic Weighted Kappa value exceeds about 0.6;
wherein the multidimensional scoring model comprises a logistic regression machine learning model.
